(19) United States
(12) Patent Application Publication
(10) Pub. No.: US 2021/0323251 A1
(43) Pub. Date: Oct. 21, 2021

(54) PRODUCTION LINE MOULDING ASSEMBLY FOR MANUFACTURING A NON-METALLIC ARMATURE, PRODUCTION LINE AND METHOD OF FORMING A ROD USE IN THE MANUFACTURE OF A COMPOSITE ARMATURE

(71) Applicant: LIMITED LIABILITY COMPANY "INNOTECH", Moscow (RU)

(72) Inventors: Evgeny Pavlovich ARKHIPOV, g. Rostov-na-Donu (RU); Mikhail Alekseevich PAVLICHENKOV, Moscow (RU); Dmitry Yuryevich DOYKHEN, g. Zhukovskiy (RU); Vadim Davidovich SHTERENLIKHT, Moscow (RU)

(21) Appl. No.: 17/272,996

(22) PCT Filed: Aug. 19, 2019
(86) PCT No.: PCT/RU2019/000591

§ 371 Date: Mar. 3, 2021

(30) Foreign Application Priority Data
Sep. 3, 2018 (RU) 2018131555

(51) Int. Cl. B29C 70/52; B29C 70/54

(52) U.S. Cl. CPC B29C 70/521; B29C 70/545; B29C 70/526

(57) ABSTRACT

The present invention relates to manufacturing of a non-metallic armature. More particularly, the present invention relates to thread squeezing devices and to forming of a composite armature rod. There is provided a moulding assembly allowing sequential forming of a rod and squeezing of threads after passing an impregnating bath. There is provided a production line moulding assembly for manufacturing a non-metallic armature, the moulding assembly comprising a thread squeezing assembly and further comprising at least two sequentially arranged rows of dies (100, 120, 130); wherein each row of dies comprises at least one die (101, 102, 103, 104, 105, 106, 121, 122, 123, 131); wherein each die includes a hole configured to pass adhesive-impregnated roving threads therethrough; as roving threads pass, a number of dies for passing roving threads in each subsequent row of dies is less than that of dies in a preceding row of dies, and a cross-sectional area of separate dies increases or remains; at least some of dies are provided with heating elements. A technical effect provided by the invention is an increased produceability of the moulding assembly and an improved strength of the manufactured armature rod.

### BACKGROUND OF THE INVENTION

The present invention generally relates to manufacturing of a non-metallic armature, more particularly, to thread squeezing devices and forming of a composite armature rod. There is provided a moulding assembly which allows sequential forming of a rod and squeezing of roving threads after passing an impregnating bath.

### DESCRIPTION OF RELATED ART

Known in the art are production lines for manufacturing a composite non-metallic armature, including the following sequentially arranged components: a rack with roving bobbins, an aligning device, an impregnating bath with a tensioning device, a moulding assembly comprising a thread squeezing assembly, a helically winding device, a polymerization chamber, a cooling assembly, a pulling device, and an armature cord unwinding and cutting unit.

RU 2287646 of 20 Nov. 2006 discloses a moulding assembly formed as a matrix with longitudinal channels, the matrix being positioned directly before a helically winding assembly, wherein a distance from a point where a composite armature is wound by a winding cord to the matrix is equal to (1-10) d, where d is diameter of the armature, wherein a squeezing device is made of elastic resilient material and positioned before the matrix, and an aligning device is formed as a comb, and a number of comb slots is less than a number of channels in the matrix.

Rovings exiting from said matrix take a form of 2-10 bundles immediately combined in a point «a» of the winding by the winding cord, resulting in forming of a rod with a periodic profile of the armature.

RU 2194617 of 20 Dec. 2002 discloses an alternative embodiment of the moulding assembly based on a die unit.

The die unit is comprised of a row of sequentially arranged metal dies with heating elements and with fluoroplastic inserts having cone holes with decreased diameters, wherein a profile cross-section is formed in the cone holes.

Adhesive-impregnated linen is pressurized on dies, thereby partly forming an armature cross-section, and then said linen enters a pre-polarization chamber for curing thereof. Then, the formed rod enters a profile-forming device. The rod is placed between halves of a heated conduct 8 and pressurized by the halves. Meanwhile, a periodic profile of the armature is formed, while the armature material is polymerized.

Prior art means have their advantages and disadvantages. However, the Inventers are of opinion that there is a necessity to develop alternative technical decisions which would provide the produceability of the moulding assembly and strength of the formed composite armature rod.

In particular, when forming the rod, fibers in external rows of reinforcing filler may have a greater tension and a lower amount of an adhesive, and fibers entering a center of the rod have a greater amount of an adhesive and a lower tension. In such a case, the center of the rod is formed of weakly tensioned threads, while the increased tension of threads in the center leads to still greater tension of the threads on the periphery of the impregnating bath. As a consequence of nonuniform tensions and nonuniform impregnation, the formed rod has lower strength, wherein it especially occurs when rods (of the composite armature) having relatively larger diameters (more than 16 mm) are manufactured.

An object of the present invention is extended variety of means for forming a rod of a composite armature that would provide the strength of a manufactured composite armature rod having different diameters and the produceability of a production line moulding assembly for manufacturing a non-metallic armature.

### SUMMARY OF INVENTION

In one aspect of the invention, there is provided a production line moulding assembly for manufacturing a non-metallic armature, the moulding assembly comprising a thread squeezing assembly and further comprising:

at least two sequentially arranged rows of squeezing dies, wherein

each row of squeezing dies comprises at least one squeezing die;

each squeezing die includes a hole configured to pass adhesive-impregnated roving threads therethrough;

as roving threads pass, a number of squeezing dies for passing roving threads in each subsequent row of squeezing dies is less than that of squeezing dies in a preceding row of squeezing dies, and a cross-sectional area of separate squeezing dies increases or remains;

at least some of squeezing dies are provided with heating elements configured to provide a predetermined temperature squeezing condition.

In an embodiment of the present invention, the moulding assembly is configured to be mounted directly after an impregnating bath.

In an embodiment of the present invention, the moulding assembly further comprises squeezing cutters mounted before the sequentially arranged row of squeezing dies.

In an embodiment of the present invention, the moulding assembly comprises at least one additional row of squeezing dies to form at least three sequentially arranged rows of squeezing dies.

In an embodiment of the present invention, a total area of squeezing die holes for each subsequent row of squeezing dies is equal to that of squeezing die holes for a preceding row of squeezing dies with a possible variation within +/−10%.

In an embodiment of the present invention, squeezing dies in a single row of squeezing dies have identical (equal) cross-sectional areas.

In an embodiment of the present invention, a cross-sectional area of at least one of squeezing dies in a single row of squeezing dies differs from that of other squeezing dies.

In an embodiment of the present invention, the squeezing die holes have geometrical shape chosen from the following shapes: blunted cone and cylinder.

In another aspect of the invention, there is provided a production line for manufacturing a composite armature, the production line comprising the following sequentially arranged components: a rack with roving bobbins; an aligning device; an impregnating bath with a tensioning device; a moulding assembly comprising a thread squeezing assembly; a winding assembly; a polymerization chamber; a cooling assembly; a pulling device; and an armature cord unwinding and cutting unit; wherein the moulding assembly comprises at least two sequentially arranged rows of squeezing dies; wherein each row of squeezing dies comprises at least one squeezing die; wherein each squeezing die includes a hole configured to pass adhesive-impregnated roving threads therethrough; wherein a number of squeezing dies in a subsequent row is reduced in an output direction, and a cross-sectional area of separate squeezing dies increases or remains in the output direction; wherein at least some of squeezing dies are provided with heating elements configured to provide a predetermined temperature squeezing condition.

In an embodiment of the production line according to the present invention, the rack with roving bobbins includes at least two types of roving threads, the roving being chosen from the following: a glass roving, a basalt roving, a hydrocarbon roving, and an aramid roving; wherein the moulding assembly is configured to sequentially combine adhesive-impregnated thread bundles of the roving having at least two types when passing through the at least two sequentially arranged rows of squeezing dies of the moulding assembly.

In still another aspect of the invention, there is provided a method of forming a rod for use in the manufacture of a composite armature, the method including: passing adhesive-impregnated roving threads through at least two sequentially arranged rows of squeezing dies; wherein each row of squeezing dies comprises at least one squeezing die; sequentially combining roving thread bundles as a number of squeezing dies in a subsequent row is reduced in an output direction, and a cross-sectional area of separate squeezing dies increases or remains in the output direction; heating roving thread bundles when passing through the squeezing dies to a predetermined temperature to provide a predetermined temperature squeezing condition so as to form a structure of the rod; forming the rod in a polymerization chamber.

In an embodiment of the method, the step of passing adhesive-impregnated roving threads is performed by at least one additional row of squeezing dies to form at least three sequentially arranged rows of squeezing dies.

In an embodiment of the method, the step of passing adhesive-impregnated roving threads is performed by squeezing dies having identical (equal) cross-sectional areas in a single row of squeezing dies.

In an embodiment of the method, the step of passing adhesive-impregnated roving threads is performed by squeezing dies, wherein a cross-sectional area of at least one of the squeezing dies in a single row of squeezing dies differs from that of other squeezing dies.

In an embodiment of the method, at least two types of roving threads is passed through the squeezing dies, the roving being chosen from the following: glass roving, a basalt roving, a hydrocarbon roving, an aramid roving, wherein the rod structure is formed of bundles of the roving threads having at least two types.

A technical effect provided by the invention is increased produceability of the moulding assembly and an improved strength of the manufactured armature rod. The produceability and the improved strength of the manufactured rod are provided by sequential combination of roving threads, sequential polymerization thereof and uniform tension of the threads throughout the cross-section of the formed rod while maintaining a high production speed. The present invention further allows a required squeezing level for articles having a relatively large diameter (more than 16 mm) in required zones of the article cross-section. According to some embodiments of the present invention, the improved strength of the manufactured armature rod and the produceability of the moulding assembly are provided due to allowed combination of different types of continuous fibers in a predetermined configuration inside the article rod. For example, it is provided when bundles are equidistantly added to an external layer in relation to an article center or fibers having characteristics differing in mass from that of a main filler are precisely positioned in the article center.

The reinforcing filler: a material or an article connected to a thermosetting resin before staring of a curing process to enhance physical and mechanical characteristics of a polymer composite.

In the description, the term «reinforcing filler» means a reinforcing filler made of a continuous fiber. Continuous reinforcing fillers (rovings) made of glass fiber, basalt fiber, carbon fiber and aramid fiber are commonly used to manufacture a composite armature.

In the description, the term «roving» means: flexible extended, continuous and firm body having a limited length and cross-sectional dimensions being smaller than the length, wherein the body is used to manufacture fiber materials intended to reinforce polymer composites.

Below described are examples of different types of the reinforcing filler (roving).

A glass fiber (roving); fiberglass: a fiber for reinforcing polymer composites, the fiber being made of an inorganic glass melt.

A basalt fiber (roving); basaltfiber: a fiber for reinforcing polymer composites, the fiber being formed of a basalt melt or a gabbro-diabase.

A carbon fiber (roving); carbonfiber: a fiber for reinforcing polymer composites, the fiber being formed by performing pyrolysis of organic fiber precursors and containing at least 90% mass. carbon (the precursors are referred to, for example, as polyacrylonitrile or hydrocellulose fibers). Depending on an ultimate strength and an elastic modulus, carbon fibers are divided into general-purpose fibers, high strength, medium modulus, high modulus and ultra-high modulus).

An aramid fiber (roving): a fiber for reinforcing polymer composites, the fiber being formed of linear fiber-forming polyamides where at least 85% amide groups are directly associated with two aromatic rings.

### BRIEF DESCRIPTION OF THE DRAWINGS

FIG. 1 shows an illustrative example of one of a plurality of embodiments of the sequentially arranged rows of squeezing dies in a moulding assembly.

FIG. 2 shows an illustrative example of one of a plurality of embodiments of the sequentially arranged rows of squeezing dies in a moulding assembly.

### DESCRIPTION OF THE PREFERRED EMBODIMENTS

A technology of producing a composite armature is generally well-known for one skilled in the art and, thus, each step of the technology will not be described in details. The technology is based on the «pultrusion»—forming of elongated molded parts by continuously extending of a reinforcing material impregnated with an adhesive through a heated forming die.

It is to note that a production line may include the following sequentially arranged components: a rack with roving bobbins; an aligning device; an impregnating bath with a tensioning device; a moulding assembly with a thread squeezing assembly; a winding assembly; a polymerization chamber; a cooling assembly; a pulling device; and an armature cord unwinding and cutting unit.

The rack with roving bobbins may be formed, for example, as a row of shelfs where rods are arranged to mount roving bobbins and to allow unwinding of the roving bobbins, for example, by rotation thereof about an axis of the rods.

The rovings can be formed of mineral (glass, basalt, carbon, etc.) or polymer (capron, polyester, etc.) threads. In an embodiment of the present invention, rovings differing in composition can be placed on the rack with roving bobbins. For example, one part of the bobbins may have a roving made of glass threads, and the remaining part of the bobbins may have a roving made of basalt threads. Other combinations having a different content and a different number of roving types are possible. In particular, three different number of roving types can be used, for example, rovings made of glass, basalt and carbon threads. A number of the bobbins on the rack and their composition are chosen based on a type and a diameter of the manufactured composite armature.

Use of different roving types will be explained in details in the below description of particular examples.

The aligning device is intended to uniformly supply the rovings to the impregnating bath.

The impregnating bath may be provided with a heating element to provide a required temperature impregnation condition. After the impregnating bath, rovings pass to the moulding assembly.

The moulding assembly is one aspect of the invention and will be described in details below.

The moulding assembly can be mounted directly after the impregnating bath.

The production line moulding assembly for manufacturing a non-metallic armature includes a thread squeezing assembly and comprises at least two sequentially arranged rows of squeezing dies.

The sequentially arranged rows of squeezing dies are configured to provide squeezing of separate threads and sequential forming of a rod of the composite armature.

A number of the sequentially arranged rows of squeezing dies is chosen based on a type, a diameter, a required strength, a required squeezing level and other parameters of the manufactured composite armature. Thus, for example, two sequentially arranged rows of squeezing dies may be enough for manufacturing a composite armature with a diameter of 4 mm. If it is required to provide more uniform squeezing, a number of rows of squeezing dies may be increased, for example, up to three (3) or five (5). For example, seven sequentially arranged rows of squeezing dies may be used for manufacturing a composite armature with a diameter of 20 mm.

A number of squeezing dies in each row is chosen based on a type, a diameter, a required strength, a required squeezing level and other parameters of the manufactured composite armature.

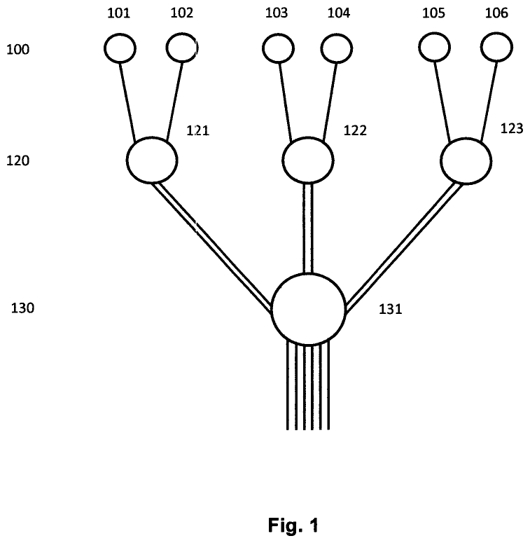

Each row of squeezing dies in two or more sequentially arranged rows of squeezing dies comprises at least one squeezing die. FIG. 1 shows an illustrative example where the first row of squeezing dies 100 is comprised of six (6) squeezing dies (101, 102, 103, 104, 105, and 106) configured to pass adhesive-impregnated roving threads and having the same diameter. The second row of squeezing dies 120 is comprised of three (3) squeezing dies (121, 122, and 123). Roving threads from two squeezing dies 101 and 102 of the first row of squeezing dies 100 enter the squeezing die 121 to form roving thread bundles. Similarly, in the present illustrative example, roving threads from two squeezing dies 103 and 104 enter the squeezing die 122, and roving threads from squeezing dies 105 and 106 enter the squeezing die 123. The third row of squeezing dies 130 is comprised of only one squeezing die 131, and three thread bundles of the roving from squeezing dies 121, 122 and 123 of the second row of squeezing dies 120 enter the squeezing die 131.

Each squeezing die includes a hole configured to pass adhesive-impregnated roving threads therethrough. The roving threads means, in the context of the present description, one or more roving threads combined to bundles (roving thread bundles). A shape and a diameter of the squeezing dies are chosen based on a thickness of the roving threads and on a required adhesive squeezing level (a required thickness). Diameters of the squeezing dies in a single row may be identical or at least partly differ, for example to provide different squeezing level for threads/roving thread bundles in different portion of the formed composite armature rod or to combine a different number of threads/roving thread bundles.

In an embodiment of the present invention, a total area of the squeezing die holes for each subsequent row of squeezing dies substantially is equal to that of the squeezing die holes of the preceding row with a possible variation within +/−10%. Consequently, a total area of holes for each subsequent row of squeezing dies may be equal or slightly higher or lower (within said range from −10% to +10%) of that of the preceding row of squeezing dies. All the above embodiments are covered by the term «is equal to» in the description. As shown in FIG. 1, a diameter of each squeezing die of the second row 120 is equal to two diameters of squeezing dies of the first row of squeezing dies 100. A diameter of the squeezing die 121 is equal to a total diameter of the squeezing dies 101 and 102. A diameter of the squeezing die 122 is equal to a total diameter of the squeezing dies 103 and 104. A diameter of the squeezing die 123 is equal to a total diameter of the squeezing dies 105 and 106. The decreased diameter of the squeezing die in relation to the total diameter of the squeezing dies of the preceding row allows a further squeezing of combined threads or roving thread bundles. The diameter slightly increased within the predetermined limits allows combining threads/thread bundles with a large volume of an adhesive.

Similarly, in the third row of squeezing dies 130 as shown in the illustrative example in FIG. 1, a diameter of the squeezing die 131 is equal to a total diameter of three squeezing dies 121, 122, and 123 of the second row of squeezing dies 120.

As shown in the illustrative example of FIG. 1, a number of squeezing dies in a subsequent row is reduced in an output direction, and a cross-sectional area of separate squeezing dies increases or remains in the output direction.

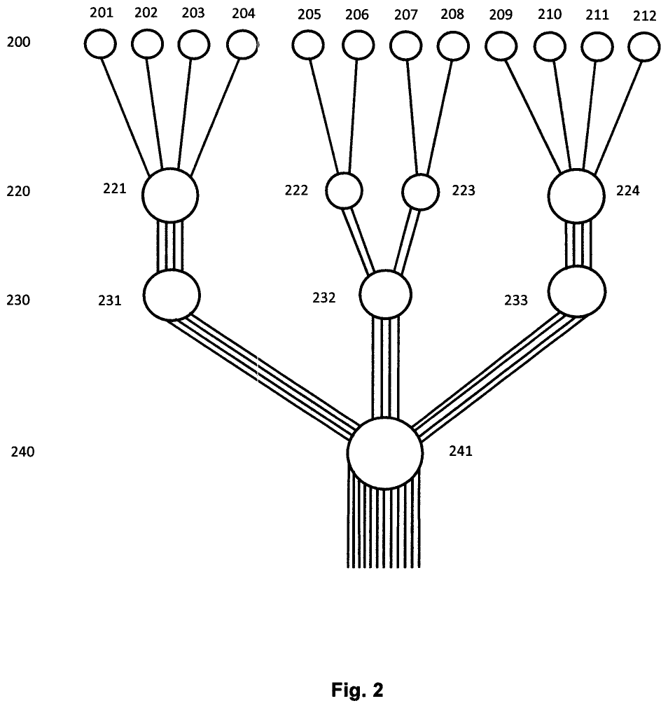

FIG. 2 shows another illustrative example of one of a plurality of embodiments of sequentially arranged rows of squeezing dies in a moulding assembly where the first row of squeezing dies 200 is comprised of twelve squeezing dies (201, 202, 203, 204, 205, 206, 207, 208, 209, 210, 211 and 212), wherein squeezing dies 205, 206, 207 and 208 arranged in the center have lower diameter than squeezing dies 201, 202, 203, 204, 209, 210, 211 and 212 arranged on each side. Difference in squeezing die diameters allows regulating of squeezing and forming of the rod with rovings having a different squeezing level. As shown in the illustrative example of FIG. 2, the center of the rod may be formed of more squeezed rovings (with a lower amount of an adhesive). The second row of squeezing dies 220 is comprised of four squeezing dies (221, 222, 223 and 224). Roving threads from four squeezing dies 201, 202, 203 and 204 of the first row of squeezing dies 200 enter the squeezing die 221. Similarly, roving threads from four squeezing dies 209, 210, 211 and 212 enter the squeezing die 224. Only two roving threads of the first row of squeezing dies 200 enter each of squeezing dies 222 and 223: (205, 206) enter the squeezing die 222, and (207, 208) enter the squeezing die 223, respectively.

The third row of squeezing dies 230 is comprised of three squeezing dies 231, 232, and 233. A bundle of roving threads from only one squeezing die 221 of the second row of squeezing dies enters the squeezing die 231, and one bundle of roving threads from squeezing die 224 of the second row of squeezing dies 220 enters the squeezing die 233. Two thread bundles of the roving from squeezing dies 222 and 223 of the second row of squeezing dies enter the squeezing die 232.

The fourth row of squeezing dies 240 is comprised of only one squeezing die 241, and three thread bundles of the roving from squeezing dies 231, 232 and 233 of the third row of squeezing dies 230 enter said squeezing die 241.

A total area of holes for each subsequent row of squeezing dies may be equal to that of the squeezing die holes of the preceding row with a possible variation within +/−10%. Consequently, a total area of holes for each subsequent row of squeezing dies may be equal or slightly higher or lower (within said range from −10% to +10%) of that of the preceding row of squeezing dies. All the above embodiments are covered by the term «is equal to» in the description. As shown in FIG. 2, a diameter of squeezing dies 221 and 224 of the second row 220 is equal to four diameters of squeezing dies of the first row of squeezing dies 200 (201, 202, 203, 204, and 209, 210, 211, 212). A diameter of squeezing dies 222 and 223 of the second row of squeezing dies is equal to two diameters of squeezing dies of the first row of squeezing dies 200 (205, 206 and 207, 208).

Meanwhile, a diameter of squeezing dies 222 and 223 used to form a center of the rod is lower than that of squeezing dies 221 and 224 in the same row of squeezing dies 220. The decreased diameter of the squeezing dies 222 and 223 provides more sequentially combining (two (2) threads instead of four (4) threads) and greater squeezing of roving threads (initially, squeezing of one (1) thread, and then a bundle of two threads instead of squeezing of one (1) thread, then combining and squeezing four (4) threads at once) to form a center of the rod and to increase its rigidity due to reduced amount of an adhesive and increased density of roving threads in the center of the formed rod.

In the third row of squeezing dies 230, diameters of the squeezing dies 231 and 233 are identical and equal to that of squeezing dies of the second row 221 and 224, respectively. A diameter of squeezing die 232 in the third row of squeezing dies 230 is equal to a total diameter of the squeezing dies 222 and 223 in the second row of squeezing dies 220.

As shown in FIG. 2, the fourth row of squeezing dies 240 comprises only one squeezing die 241 where combining all roving thread bundles from squeezing dies 231, 232 and 233 of the third row of squeezing dies 230 and forming a structure of the composite armature rod are performed. Therefore, the center of the rod is formed of more uniformly squeezed and sequentially formed roving thread bundles leaving the squeezing die 232.

The squeezing dies in each row of squeezing dies or at least some rows of squeezing dies are provided with heating elements to provide a predetermined temperature squeezing condition. The squeezing dies may be heated, for example, by thermoelectric heaters, microwave heaters or infrared industrial heaters-emitters. Other examples of the used heaters and a squeezing die heating circuit are possible depending on features of an industrial environment, powers, a type and a diameter of the manufactured composite armature. Both the squeezing die itself and areas of the moulding assembly can be heated, for example, before the roving threads enter the squeezing die or after the threads pass through the squeezing die.

Heating of squeezing dies at an outlet velocity of 3-4 m/min provides heating of an adhesive in a contact area up to 80-120 degrees (depending on settings and diameters of articles), wherein the adhesive significantly reduces its viscosity, and the best adhesive impregnation of continuous fibers is provided.

A polymerization reaction is triggered, thereby allowing a time of presence of the rod in the polymerization chamber to be reduced and further providing the produceability of the moulding assembly and the production line for manufacturing a composite non-metallic armature as a whole.

In an embodiment, different squeezing dies are heated by heaters of different types and a principle of operation. For example, heating of squeezing dies to form a center of the rod is performed by a heater of one type, and other squeezing dies are heated by a heater of another type.

In an embodiment, squeezing die holes have geometrical shape chosen from the following shapes: blunted cone and cylinder.

The moulding assembly may further include squeezing cutters mounted before a sequentially arranged row of squeezing dies. Squeezing cutters are configured to preliminary squeeze of roving threads before sequential squeezing thereof and combining in the sequentially arranged squeezing dies. It allows increasing of the produceability for the moulding assembly due to increased speed of forming of the composite armature rod.

At the output of the moulding assembly comprising a thread squeezing assembly, there is formed a rod with a predetermined profile, a precise arrangement of threads and uniform tension of threads therethrough the cross-section of the rod due to sequential combination and squeezing of roving thread bundles while keeping a high production rate. Further, the present invention allows a required adjustable squeezing level for articles having a relatively large diameter (more than 16 mm) in required areas of the article cross-section.

Further increasing of the strength may be provided by using a combination of different types of roving threads. For example, it is provided when bundles are equidistantly added to an external layer in relation to the article center or when fibers having characteristics differing in mass from that of a main filler are precisely positioned in the article center.

The formed rod of the armature then moves to a winding assembly which is configured to create a periodic profile on a surface of the armature rod, for example, by helically winding the roving threads about an axis of the rod.

After the winding assembly the armature passes through the polymerization chamber where removing of volatile substances and sintering (polymerization) of the adhesive to a one-piece article are performed at a temperature up to 400° C. The heating is performed, for example, by means of a thermoelectric heater, a microwave heater or an infrared industrial heater-emitter. Once sintering of the armature is finished, it is passed through the cooling assembly (where it is cooled to a predetermined temperature), the pulling device, and the armature cord unwinding and cutting unit.

Several particular embodiments of the moulding assembly of the present invention for the production line for manufacturing the composite armature will be described below.

### EXAMPLE 1 MANUFACTURING OF A COMPOSITE ARMATURE ROD WITH A DIAMETER OF 40 MM

The moulding assembly comprises four sequentially arranged rows of squeezing dies. The first row of squeezing dies includes ninety-six (96) squeezing dies. A diameter of each squeezing die is 4 mm, and seven (7) threads of an adhesive-impregnated glass roving enter each squeezing die.

A second row of squeezing dies includes twenty-four (24) squeezing dies with a diameter of 8 mm. Four (4) roving thread bundles formed in the first row of squeezing dies enter each squeezing die of the second row of squeezing dies.

A third row of squeezing dies includes eight (8) squeezing dies each having a diameter of 14 mm. Three (3) roving thread bundles formed in the second row of squeezing dies enter each squeezing die of the third row of squeezing dies.

A fourth row of squeezing dies comprises only one squeezing die with a diameter of 40 mm, and eight (8) roving thread bundles formed in the third row of squeezing dies enter said squeezing die. Therefore, the rod having a diameter of 40 mm is formed at the output of the fourth row of squeezing dies.

### EXAMPLE 2 MANUFACTURING OF A COMPOSITE ARMATURE ROD WITH A DIAMETER OF 28 MM

The moulding assembly comprises four sequentially arranged rows of squeezing dies. The first row of squeezing dies includes forty-eight (48) squeezing dies with a diameter of 4 mm. Seven (7) threads of adhesive-impregnated basalt roving enter each squeezing die.

A second row of squeezing dies includes twelve (12) squeezing dies with a diameter of 8 mm. Four (4) roving thread bundles formed in the first row of squeezing dies enter each squeezing die of the second row of squeezing dies.

A third row of squeezing dies includes four (4) squeezing dies each having a diameter of 14 mm. Three (3) roving thread bundles formed in the second row of squeezing dies enter each squeezing die of the third row of squeezing dies.

A fourth row of squeezing dies comprises only one squeezing die with a diameter of 28 mm, and four (4) roving thread bundles formed in the third row of squeezing dies enter said squeezing die. Therefore, the rod having a diameter of 28 mm with a uniform distribution of forty-eight (48) basalt roving bundles each including seven (7) threads is formed at the output of the fourth row of squeezing dies.

### EXAMPLE 3 MANUFACTURING OF A COMPOSITE ARMATURE ROD WITH A DIAMETER OF 28 MM FROM COMBINED ROVING THREADS

The moulding assembly comprises four sequentially arranged rows of squeezing dies. A first row of squeezing dies includes forty-eight (48) squeezing dies with a diameter of 4 mm. Seven (7) adhesive-impregnated threads enter each squeezing die: one (1) basalt roving thread in the center, and six (6) glass roving threads on the periphery.

A second row of squeezing dies includes twelve (12) squeezing dies with a diameter of 8 mm. Four (4) roving thread bundles formed in the first row of squeezing dies enter each squeezing die of the second row of squeezing dies. Meanwhile, each of the bundles is formed of the basalt roving thread surrounded by six (6) glass roving threads.

A third row of squeezing dies includes four (4) squeezing dies each having a diameter of 14 mm. Three (3) roving thread bundles formed in the second row of squeezing dies enter each squeezing die of the third row of squeezing dies.

A fourth row of squeezing dies comprises only one squeezing die with a diameter of 28 mm, and four (4) roving thread bundles formed in the third row of squeezing dies enter said squeezing die. Therefore, formed at the output of the fourth row of squeezing dies is the rod with a diameter of 28 mm having a uniform distribution of forty-eight (48) combined roving bundles each including one (1) basalt roving thread in the center and six (6) glass roving threads on the periphery.

### EXAMPLE 4 MANUFACTURING OF A COMPOSITE ARMATURE ROD WITH A DIAMETER OF 20 MM

The moulding assembly comprises six sequentially arranged rows of squeezing dies. A first row of squeezing dies includes ninety-six (96) squeezing dies. A diameter of each squeezing die is 2 mm, and two (2) threads of an adhesive-impregnated glass roving enter each squeezing die.

A second row of squeezing dies includes forty-eight (48) squeezing dies with a diameter of 3 mm. Two (2) roving thread bundles formed in the first row of squeezing dies enter each squeezing die of the second row of squeezing dies.

A third row of squeezing dies includes twenty-four (24) squeezing dies each having a diameter of 4 mm. Two (2) roving thread bundles formed in the second row of squeezing dies enter each squeezing die of the third row of squeezing dies.

A fourth row of squeezing dies comprises six (6) squeezing dies with a diameter of 8 mm, and four (4) roving thread bundles formed in the third row of squeezing dies enter said squeezing die.

A fifth row of squeezing dies includes two (2) squeezing dies each having a diameter of 14 mm. Three (3) roving thread bundles formed in the fourth row of squeezing dies enter each squeezing die of the fifth row of squeezing dies.

A sixth row of squeezing dies includes only one squeezing die with a diameter of 20 mm, and two (2) roving thread bundles formed in the fifth row of squeezing dies enter said squeezing die.

Therefore, the rod having a diameter of 20 mm is formed at the output of a sixth row of squeezing dies.

The disclosed illustrative embodiments, examples and description provide better understanding of the claimed inventions and the technology and cannot be considered as a limitation. Other possible embodiments will be clear for one skilled in the art after reading the above description. A scope of the present invention is limited only by the enclosed claims.

1. A production line moulding assembly for manufacturing a non-metallic armature, comprising:
a thread squeezing assembly,
at least two sequentially arranged rows of dies; wherein each row of dies comprises at least one die;
each die includes a hole configured to pass adhesive-impregnated roving threads therethrough;
as roving threads pass, a number of dies for passing roving threads in each subsequent row of dies is less than that of dies in a preceding row of dies, and a cross-sectional area of separate dies increases or remains;
at least some of dies are provided with heating elements.

2. The moulding assembly according to claim 1, wherein the moulding assembly is configured to be mounted directly after an impregnating bath.

3. The moulding assembly according to claim 1, further comprising squeezing cutters mounted before the sequentially arranged row of dies.

4. The moulding assembly according to claim 1, wherein a total area of the die holes for each subsequent row of dies is equal to that of the die holes for a preceding row with a possible variation within +/−10%.

5. The moulding assembly according to claim 1, wherein the moulding assembly comprises at least one additional row of dies to form at least three sequentially arranged rows of dies.

6. The moulding assembly according to claim 1, wherein dies in a single row of dies have identical cross-sectional areas.

7. The moulding assembly according to claim 1, wherein a cross-sectional area of at least one of dies in a single row of dies differs from that of other dies.

8. The moulding assembly according to claim 1, wherein the die holes have a geometrical shape chosen from the following shapes: blunted cone and cylinder.

9. A production line for manufacturing a composite armature, the production line comprising sequentially arranged: a rack with roving bobbins; an aligning device; an impregnating bath with a tensioning device; a moulding assembly comprising a thread squeezing assembly; a winding assembly; a polymerization chamber; a cooling assembly; a pulling device; and an armature cord unwinding and cutting unit, wherein the moulding assembly comprises at least two sequentially arranged rows of dies, wherein each row of dies comprises at least one die; wherein each die includes a hole configured to pass adhesive-impregnated roving threads therethrough; wherein a number of dies in a subsequent row is reduced in an output direction, and a cross-sectional area of separate dies increases or remains in the output direction; at least some of dies are provided with heating elements.

10. The production line according to claim 9, wherein the rack with roving bobbins includes at least two types of roving threads, the roving being chosen from the following: glass roving, a basalt roving, a hydrocarbon roving, and an aramid roving; wherein the moulding assembly is configured to sequentially combine adhesive-impregnated roving thread bundles having at least two types when passing through the at least two sequentially arranged rows of dies of the moulding assembly.

11. A method of forming a rod for use in the manufacture of a composite armature, the method including:
passing adhesive-impregnated roving threads through at least two sequentially arranged rows of dies; wherein each row of dies comprises at least one die;
sequentially combining roving thread bundles as a number of dies in a subsequent row is reduced in an output direction, and a cross-sectional area of separate dies increases or remains in the output direction;
heating the roving thread bundles when passing through the dies to a predetermined temperature so as to form a structure of the rod and provide sequential polymerization thereof;
forming the rod in a polymerization chamber.

12. The method according to claim 11, wherein the step of passing adhesive-impregnated roving threads is performed by at least one additional row of dies so as to form at least three sequentially arranged rows of dies.

13. The method according to claim 11, wherein the step of passing adhesive-impregnated roving threads is performed by dies having identical cross-sectional areas in a single row of dies.

14. The method according to claim 11, wherein the step of passing adhesive-impregnated roving threads is performed by dies, wherein a cross-sectional area of at least one of the dies in a single row of dies differs from that of other dies.

15. The method according to claim 11, wherein at least two types of roving threads are passed through the dies, the roving being chosen from the following: glass roving, a basalt roving, a hydrocarbon roving, and an aramid roving, wherein the rod structure is formed of bundles of the roving threads having at least two types.
